(19) United States
(12) Patent Application Publication
(10) Pub. No.: US 2004/0083410 A1
(43) Pub. Date: Apr. 29, 2004

(54) Systems and methods to improve silicon debug of speed failures in memory arrays

(76) Inventor: Douglas J. Cutter, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/282,698

(22) Filed: Oct. 29, 2002

(51) Int. Cl. G06F 11/34

(52) U.S. Cl. 714/57

(57) ABSTRACT

The invention comprises a system and method for testing a component, wherein the component comprises a plurality of elements. The invention comprises a tester that subjects the plurality of elements to a plurality of tests, wherein the plurality of tests has a criteria, each test of the plurality of tests has the criteria at a value, and each value is different for each test. The invention comprises a plotter that receives a plurality of results from the plurality of tests and forms a bit map comprising a plurality of sections, wherein each section depicts at least a portion of the component and locations for any failing elements within the portion, and each section represents the result of a test of the plurality of tests.

### FIELD OF THE INVENTION

This invention relates in general to computer components and in specific to systems and methods for analyzing failures in computer components.

### DESCRIPTION OF RELATED ART

Computer components typically comprise many smaller elements. For example, a memory chip may comprise millions of memory elements arranged in a row and column organization referred to as an array. Each element or location may be uniquely addressed by row and column location.

Failures in the elements of such components typically arise from one of two sources. One source is the formation of the component. During formation of the computer components, there are variations in the processing. Thus, one element may have a part that is too thick or too far away from another part than called for in the design. Such variations can cause failure of the element. Another source is in the design of the component. Failure causing errors can be introduced into the design by changes or by failing to recognize such errors during the simulation of the design. In any event, computer components can suffer from the failure of one or more of its elements.

Such failures are typically located through the testing of the manufactured component. The component is placed into test equipment and provided with power and known data. The outputs of the component are then tested to determine whether the component properly performed its tasks, and if not, what portion of the component failed. Testing may involve operating the component across the operational specifications for the component. Other testing may involve using values outside of the range of the operational specification. For example, the component may be tested at a voltage that exceeds (or is lower than) the operational voltage, as well as, at a clock frequency that exceeds (or is lower than) the operational clock frequency of the component.

A distribution of the faulty elements can be visually perceived by plotting the positions of the faulty elements. Such a plot is known as a bit map and is effective for use in failure analysis of computer components, e.g. memory arrays. Thus, the bit map represents a physical mapping of the locations of a failing element based on the address location of the element. An example of a bit map 100 is shown in FIG. 1. The outline 101 of the plot 100 is representative of the borders of the component. Each dot 102 on the plot represents the failure of one element of the component, e.g. one memory location in the memory array.

### BRIEF SUMMARY OF THE INVENTION

The invention comprises a system and method for testing a component, wherein the component comprises a plurality of elements. The invention comprises a tester that subjects the plurality of elements to a plurality of tests, wherein the plurality of tests has a criteria, each test of the plurality of tests has the criteria at a value, and each value is different for each test. The invention comprises a plotter that receives a plurality of results from the plurality of tests and forms a bit map comprising a plurality of sections, wherein each section depicts at least a portion of the component and locations for any failing elements within the portion, and each section represents the result of a test of the plurality of tests.

### BRIEF DESCRIPTION OF THE DRAWINGS

FIG. 1 depicts a prior art bit map;

FIG. 2 depicts an example of a system for performing the invention;

FIG. 3 depicts an example of a method of performing an embodiment of the invention;

FIG. 4 depicts an example of a method of performing an aspect of the method of FIG. 3, according to an embodiment of the invention.

FIG. 5 depicts an example of a bit map formed according to an embodiment of the invention;

FIG. 6 depicts another example of a bit map formed according to an embodiment of the invention; and

FIG. 7 depicts a block diagram of a computer system which is adapted to use the present invention.

### DETAILED DESCRIPTION

Prior art bit maps, e.g. bit map 100 of FIG. 1, typically only show failures at a single frequency or at a single voltage level. However, improvements in computer systems, particularly processors, often require that computer components operate at higher and higher clock frequencies and/or lower and lower voltages. Thus, the prior art bit maps are not able to provide enough information for failure analysis of the component.

The invention comprises systems and methods for plotting a series of bitmaps, wherein the bitmaps are arranged in a particular order and show how changes in a particular variable (or variables) affect the failure of the elements. For example, the invention may be used to depict how changes in frequency affect the failure of memory elements in a memory array. As another example, the invention may be used to depict how changes in voltage affects the failure of memory elements in a memory array. Note that frequency and voltage are by way of example only, as other criteria could be used, for example, temperature, clock skew, power, supply noise, or substrate voltages.

The invention provides an immediately perceivable representation of how a variable criterion affects the failures across a computer component. The invention consolidates large amounts of information into one plot. Embodiments of the invention allow portions or sub-sections of the component to be compared with respect to the changes in the variable criteria. Embodiments of the invention allow side-by-side comparisons of failures at each increment of the variable criteria. Embodiments of the invention also allow test condition information to be stored and printed for each increment. For example, part number, lot description, test temperature, test voltage, test frequency, test pattern name, or date of testing.

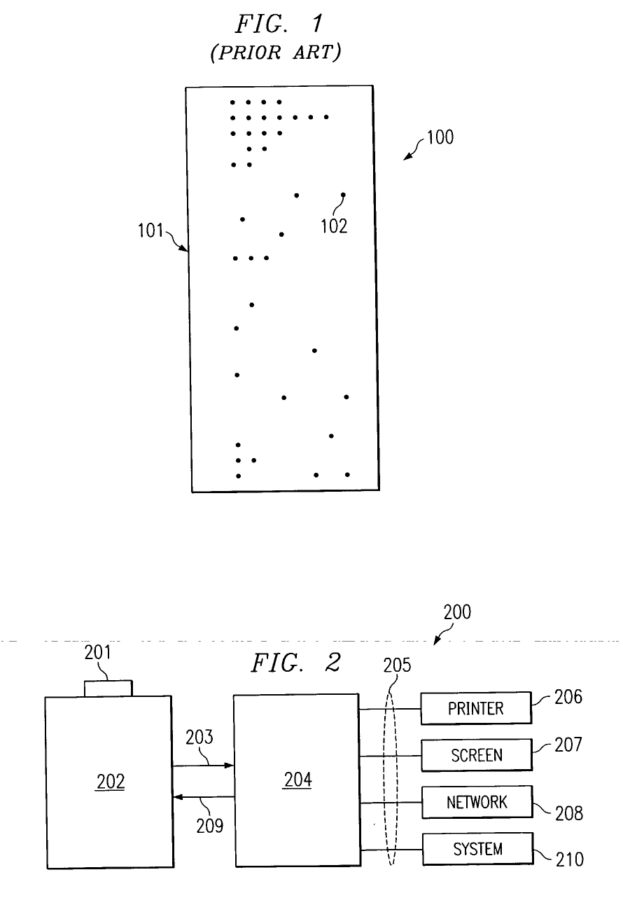

FIG. 2 depicts an example of a system 200 implementing an embodiment of the invention. Note that system 200 is by way of example only, as other systems could be developed that implement the invention. Component 201 is connected to tester 202 (Note that 201 is preferably not part of system 200). Component 201 may be a processor, a memory component, or any other computer application special integrated circuit (ASIC), digital signal processor (DSP), or any other circuit component. Tester 202 may comprise functional test equipment or a prototype system. Tester 202 supplies component 201 with whatever resources are desired for testing, by way of example but not limited to clock signal(s), power, data and address signal(s), output port(s), test pin(s), heat sink(s), and cooling. Tester 202 would also apply the criteria for the test to the component 201. Tester can check for operational failures of component 201 during the application of the criteria. For example, tester 202 can change (increment or decrement) a clock signal being delivered to component 202, and detect when the component or when one or more elements of the component fail to operate properly. As another example, tester 202 can change (or increment) a power voltage being delivered to component 202, and detect when the component or when one or more elements of the component fail to operate properly. The tester may subject the component to other types of criteria, for example clock skew, power supply noise, or substrate voltage, and detect when the component or when one or more elements of the component fail to operate properly. A failure of or in the component occurs when the component or an element of the component fails to operate properly, output an expected value, or perform a task at a particular time period. Note that the tester may comprise a function of a computer (as described below).

The results 203 from the test are provided to plotter 204. Preferably, the invention performs a series of tests on the component 201 and varies a criteria in each test. The results of each test are preferably maintained in the plotter 204. Plotter 204 can provide test data 209 to the tester 202 to control the test being performed on component 201, as well as the test criteria being applied to the component 201. Alternatively, such control information may be provided to the tester 202 from a source (not shown) that is external to the system 200. After completion of the desired tests or testing criteria, the plotter uses the results 203 from the tests to form a bit map depicting the location of failures within the component 202. The bit map may be printed on printer 206, displayed on screen 207, provided to a system (not shown) that is external to system 200 via network 208, or provided to analysis system 210 that would use bit map in the analysis of component 201 via connection(s) 205. The bit map is preferably used by designers in analyzing the component, e.g. to correct errors in the component. Note that the plotter may comprise a function of a computer system that includes other aspects of the invention or it may comprise a hardware device that is separate from a computer that includes other aspects of the invention. Note also that the tester and plotter may be embodied in the same system, such as the aforementioned computer system, if desired.

Test condition information may be provided along with results 203. This information preferably describes aspects of the test other than the results, for example, the value of the criteria, values for other resources being provided to the component, the temperature of the component, date of testing, time of testing, identifier of the component, identifier of the tester, name of the test, part number, lot description, test temperature, test voltage, test frequency, or test pattern name. This information may be stored by plotter 204 along with the results 203, or in a different file within the plotter 204. Alternatively, this information may be stored in a location (not shown) that is external to system 200. Note that this information, while useful, is optional.

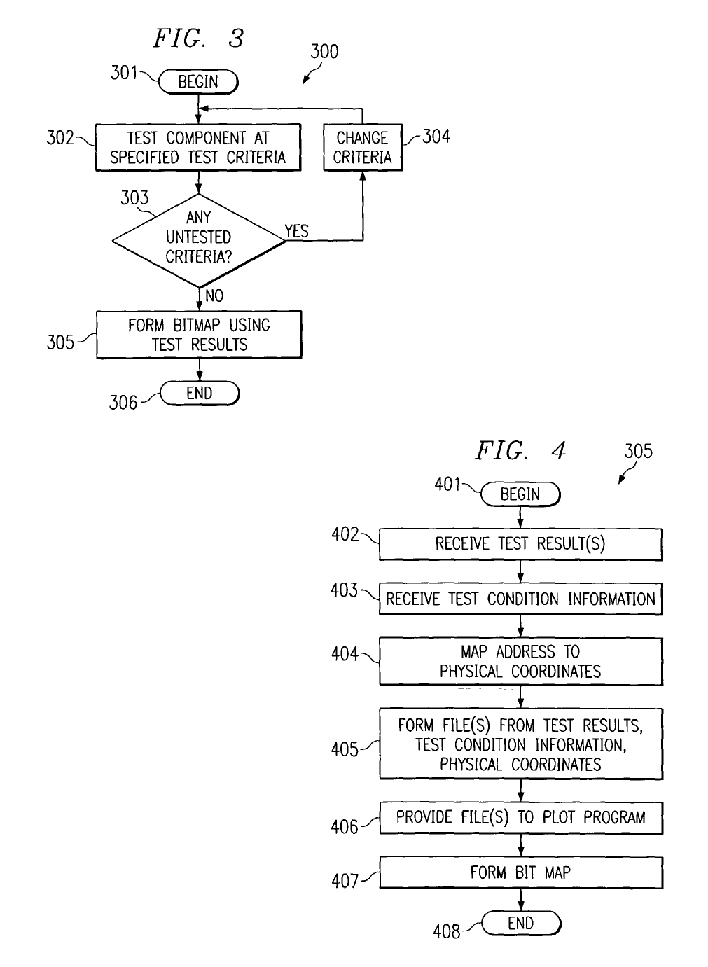

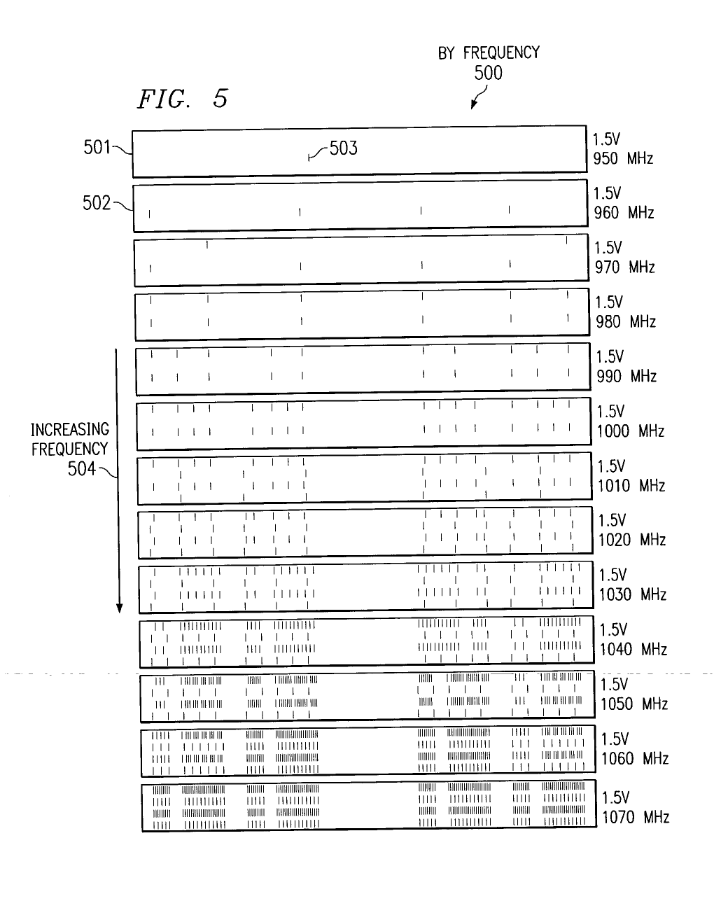

FIG. 3 depicts an example of a method 300 for implementing an embodiment of the invention. Note that method 300 is by way of example only, as other methods could be developed that implement the invention. Box 301 begins the method and in this box, the component 201 would be prepared for testing, e.g. placed into tester 202. In box 302, the component is tested with a test and criteria are applied to the component. This box may be performed by tester 202. Results of the test are stored, for example in plotter 204. In box 303, the method determines whether other values for the criteria are to be applied to the component. This box may be performed by tester 202, by plotter 204, or by an external controller (not shown). If so, then in box 304, the criteria are changed, and box 302 is repeated with the modified criteria. This box may be performed by tester 202, by plotter 204, or by an external controller (not shown). If the determination of box 303 is no, then the method transitions to box 305. In box 305, the method uses the test results from at least a portion of the tests performed by box 302 to form a bit map. This box may be performed by plotter 204. The method then ends in box 306.

FIG. 4 depicts an example of an embodiment of a method of performing the functions of box 305 of FIG. 3 for forming a bit map. Note that this method is by way of example only, as other methods could be developed that implement the invention. The method 305 begins with box 401, and receives test result(s) in box 402. The results may be received one at a time, or in groups. In box 403, the method receives test condition information. Note that boxes 402 and 403 may occur in any order, or contemporaneous with each other.

A portion of the results describes the location of the failure in the component. For example, if the component is a memory array, the results may include an address location of a failure. Thus, after receiving the test results from box 402, the method may convert a location of the failure into a physical coordinate location suitable for plotting (e.g. XY coordinates), via box 404. Mapping software may use custom configuration settings to perform the translation according to the memory topology for each array.

The method then forms one or more files in box 405 with the test results from box 402, the test condition information (if any) from box 403, and the physical address, e.g. X, Y coordinates of each failure, if necessary from box 404. The method then provides the file(s) to a plotting program such as EXCEL from Microsoft, or a computer aided design (CAD) program such as OPUS from Cadence. The plotting program would then form the bit map in box 407. The bit map may then be sent to a printer, a display screen, a network, or another system. The method then ends in box 408.

FIG. 5 depicts an example of a bit map 500 that is formed by an embodiment of the invention. The bit map 500 has been formed from the testing of a multi-bank memory array, but provides a view of only one bank for detailed analysis. The criteria that has been varied in the tests is clock frequency, namely from 950 MHz to 1070 MHz. A test condition is the power voltage supplied to the array, which is 1.5 volts. Portion 501 of the bit map reflects the test where the criteria is set to 950 MHz. Portion 502 of the bit map reflects the test where the criteria is set to 960 MHz. Note that the tests may occur out of order, e.g. 950, 1010, 960, 970, 1000, etc., but are preferably represented in sequence in the bit map 500. This provides a user with a better understanding of the response of the component to the variations of the criteria. Thus, as shown in FIG. 5, the portions are arranged in increasing frequency 504. Note that in portion 501, area 503 depicts some failing memory elements. Each point on the bit map represents a failing element. Also note that the failures increase as the frequency increases.

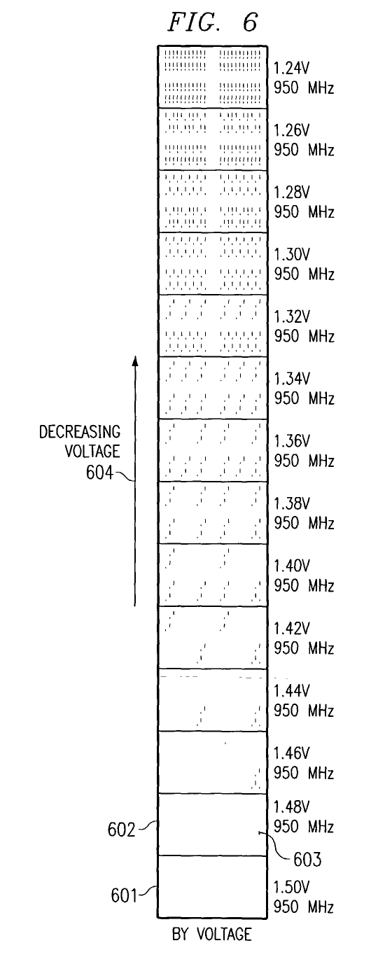

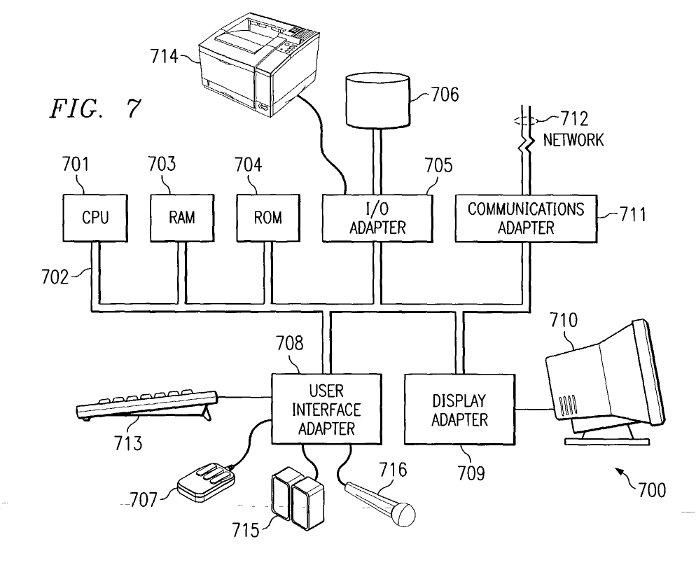

FIG. 6 depicts another example of a bit map 600 that is formed by an embodiment of the invention. The bit map 600 has been formed from the testing of a multimemory array, but displays the entire address range of the array including all the banks. The criteria that has been varied in the tests is power voltage, namely from 1.50 volts to 1.24 volts. A test condition is the clock frequency of the array, which is 950 MHz. Portion 601 of the bit map reflects the test where the criteria is set to 1.50 volts. Portion 602 of the bit map reflects the test where the criteria is set to 1.48 volts. Note that the tests may occur out of order, e.g. 1.50, 1.28, 1.30, 1.48, etc., but are preferably represented in sequence in the bit map 600. This provides a user with a better understanding of the response of the component to the variations of the criteria. Thus, as shown in FIG. 6, the portions are arranged in decreasing voltage 604. Note that in portion 602, area 603 depicts some failing memory elements. Each point on the bit map represents a failing element. Also note that the number of failures increases as the voltage decreases.

When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

FIG. 7 illustrates computer system 700 adapted to use the present invention. For example, plotter 204 may comprise system 700. Similarly, portions of tester 202 may comprise system 700, for example a support fixture (not shown) may be connected to system 700. Central processing unit (CPU) 701 is coupled to system bus 702. The CPU 701 may be any general purpose CPU, such as an HP PA-8500 or Intel Pentium processor. However, the present invention is not restricted by the architecture of CPU 701 as long as CPU 701 supports the inventive operations as described herein. Bus 702 is coupled to random access memory (RAM) 703, which may be SRAM, DRAM, or SDRAM. ROM 704 is also coupled to bus 702, which may be PROM, EPROM, or EEPROM. RAM 703 and ROM 704 hold user and system data and programs as is well known in the art.

Bus 702 is also coupled to input/output (I/O) controller card 705, communications adapter card 711, user interface card 708, and display card 709. The I/O adapter card 705 connects to storage devices 706, such as one or more of a hard drive, a CD drive, a floppy disk drive, or a tape drive to the computer system. The I/O adapter 705 is also connected to printer 714, which would allow the system to print paper copies of information such as documents, photographs, articles, etc. Note that the printer may a printer (e.g. dot matrix, laser, etc.), a fax machine, or a copier machine. Communications card 711 is adapted to couple the computer system 700 to a network 712, which may be one or more of a telephone network, a local (LAN) and/or a wide-area (WAN) network, an Ethernet network, and/or the Internet network. User interface card 708 couples user input devices, such as keyboard 713, pointing device 707, and microphone 716, to the computer system 700. User interface card 708 also provides sound output to a user via speaker(s) 715. The display card 709 is driven by CPU 701 to control the display on display device 710.

What is claimed is:

1. A system for testing a component, wherein the component comprises a plurality of elements, the system comprising:
a tester that subjects the plurality of elements to a plurality of tests, wherein the plurality of tests has a criteria, each test of the plurality of tests has the criteria at a value, and each value is different for each test; and
a plotter that receives a plurality of results from the plurality of tests and forms a bit map comprising a plurality of sections, wherein each section depicts at least a portion of the component and locations for any failing elements within the portion, and each section represents the result of a test of the plurality of tests.

2. The system of claim 1, wherein the portions of the bit map are arranged in a sequential order based on the value of the criteria.

3. The system of claim 1, wherein the plurality of tests are arranged in sequential order.

4. The system of claim 1, wherein the component is selected from the group consisting of:
a processor, a memory array, ASIC, DSP, and integrated circuit.

5. The system of claim 1, wherein the criteria is selected from the group consisting of:
a clock frequency, a power voltage, clock skew, power supply noise, and substrate voltage.

6. The system of claim 1, wherein the bit map is provided to at least one of a display screen, a printer, and a network.

7. The system of claim 1, wherein the plotter further receives test condition information that describes an aspect of the test.

8. The system of claim 7, wherein the test condition information is at least one of the information selected from the group consisting of:
a value of the criteria, a value for a resource being provided to the component, a temperature of the component, a date, a time, an identifier of the component, an identifier of the tester, a name of the test, and lot description.

9. A method for testing a component, wherein the component comprises a plurality of elements, the method comprises:
subjecting the plurality of elements to a plurality of tests, wherein the plurality of tests has a criteria, each test of the plurality of tests has the criteria at a value, and each value is different for each test;
forming a plurality of results from the plurality of tests; and
forming a bit map comprising a plurality of sections from the plurality of results, wherein each section depicts at least a portion of the component and locations for any failing elements within the portion, and each section represents the result of a test of the plurality of tests.

10. The method of claim 9, further comprising:
using the bit map to analyze the component.

11. The method of claim 9, wherein forming the bit map comprises:
forming the portions of the bit map in a sequential order based on the value of the criteria.

12. The method of claim 9, wherein subjecting the plurality of elements comprises:
arranging the plurality of tests in sequential order.

13. The method of claim 9, wherein the component is selected from the group consisting of:
a processor, a memory array, ASIC, DSP, and integrated circuit.

14. The method of claim 9, wherein the criteria is selected from the group consisting of:
a clock frequency, a power voltage, clock skew, power supply noise, and substrate voltage.

15. The method of claim 9, further comprising:
providing the bit map to at least one of a display screen, a printer, and a network.

16. The method of claim 9, wherein forming the bit map comprises:
receiving a result of the plurality of results;
mapping a location of the result to a physical coordinate; and
forming an indication of an element failure using the physical coordinate on the bit map.

17. The method of claim 16, wherein forming the bit map further comprises:
receiving test condition information that describes an aspect of the test; and
forming an indication of the test condition information on the bit map.

18. The method of claim 17, wherein the test condition information is at least one of the information selected from the group consisting of:
a value of the criteria, a value for a resource being provided to the component, a temperature of the component, a date, a time, an identifier of the component, an identifier of the tester, a name of the test, and lot description.

19. A system for testing a component, wherein the component comprises a plurality of elements, the method comprises:
means for testing the component with a plurality of tests, wherein the plurality of tests has a criteria, each test of the plurality of tests has the criteria at a value, and each value is different for each test; and
means for forming a bit map that comprises a plurality of sections from a plurality of results from the plurality of tests, wherein each section depicts at least a portion of the component and locations for any failing elements within the portion, and each section represents the result of a test of the plurality of tests.

20. A computer program product having a computer readable medium having computer program logic recorded thereon for testing a component, wherein the component comprises a plurality of elements, the computer program product comprising:
means for testing the component with a plurality of tests, wherein the plurality of tests has a criteria, each test of the plurality of tests has the criteria at a value, and each value is different for each test; and
means for forming a bit map that comprises a plurality of sections from a plurality of results from the plurality of tests, wherein each section depicts at least a portion of the component and locations for any failing elements within the portion, and each section represents the result of a test of the plurality of tests.
